(19) United States
(12) Patent Application Publication
(10) Pub. No.: US 2011/0234402 A1
(43) Pub. Date: Sep. 29, 2011

(54) You've got mail mailbox signaling device

(76) Inventor: Stephen Byrne, Levittown, NY (US)

(21) Appl. No.: 13/065,594

(22) Filed: Mar. 24, 2011

Related U.S. Application Data
(60) Provisional application No. 61/341,007, filed on Mar. 25, 2010.

(51) Int. Cl. G08B 21/00

(52) U.S. Cl. 340/540

(57) ABSTRACT

The present invention provides a transmitting and receiving system that provides an audible alert, inside the home, that mail has been left in an outside box. The transmitter is an electronic unit featuring a frequency generator, amplifier, internal antenna, and the required electrical and electronic components and circuitry encased within a durable plastic housing. Also enclosed within the plastic housing, a battery source is used to power the unit. This transmitter is wired into the flag of the mailbox, and activated as soon as the flag is raised. Rectangular in shape and containing intricate components, the receiver, which is kept inside the home, consists of a tuned frequency, receiver circuit, replaceable silver oxide battery, such as the type common to wristwatches, and a speaker, all enclosed within a sturdy, plastic housing.

### CLAIM OF PRIORITY

This patent application claims priority under 35 USC 119 (e) (1) from U.S. Provisional Patent Application Ser. No. 61/341,007 filed Mar. 25, 2010, of common inventorship herewith entitled, “You've Got Mail Mailbox Signaling Device.”

### FIELD OF THE INVENTION

The present invention pertains to the field of mail delivery systems, and more specifically to the field of mail delivery signaling systems.

### BACKGROUND OF THE INVENTION

The prior art has put forth several designs for mail delivery signaling systems. Among these are:

U.S. Pat. No. 5,036,310 to David E. Russell describes a magnetic or metal detector within a mailbox which senses the presences of the material and actuates a radio transmitter, at the mailbox, which sends a signal to a radio receiver. Upon receiving the radio signal, the radio receiver activates a telephone answering device, or an automated building control or surveillance center so that a person at a distant telephone can be advised of the mail delivery.

U.S. Pat. No. 5,247,282 to Sharron Marshall describes a delivery signal and appliance control system which generates audible or visual signal within a dwelling to indicate that a delivery, such as a newspaper or piece of mail has been deposited in a remote delivery container such as a mailbox.

U.S. Pat. No. 5,377,906 to Randall Mason describes a device for detecting and signaling the presence of an object in a closed container, comprising a housing, one or more sensors, a power sources electrically connected to one or more sensors and an optical signal and its use in providing an electronic mailbox witch allows an observer to detect the presence of mail from a remote location.

None of these prior art references describe the present invention.

### SUMMARY OF THE INVENTION

It is an object of the present invention to provide an improved mail delivery signaling system.

### BRIEF DESCRIPTION OF THE DRAWINGS

FIG. 1 shows a mailbox which, when the flag is raised, initiates a signal sent to the device of the present invention.

FIG. 2 is an elevational angled perspective view of the device of the present invention.

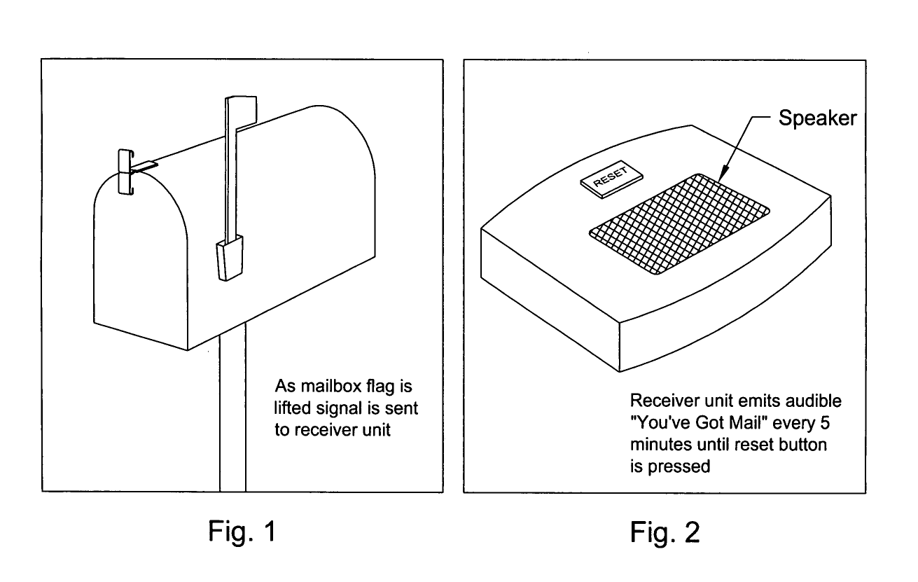

### DETAILED DESCRIPTION OF THE INVENTION

Whether receiving a weekly magazine, postcards from friends and family, bank statements, or even monthly bills, depend on the postal service to deliver important correspondence to their mailboxes each and every day. Uncomplicated receptacles, mailboxes are found in several forms, from the quaint metal boxes with upward opening flaps that are affixed to the exterior of the home to the large, multiple lock boxes common to apartment buildings and complexes. Suburban and rural homes, however, appropriate a metal or plastic compartment mounted on a post and placed next to the street or highway at the entranceway to the home. While these receptacles offer convenience, such outdoor mailboxes present a drawback.

Particularly, retrieving mail from these boxes involve a significant trek from the house to the receptacle. This is especially frustrating during inclement weather, having to brave the elements to check and see if any mail has been left at all. Since it is almost impossible to know if mail has been left in an outside box without physically checking it, many consumers readily attest to the annoyance of walking through the rain or snow, only to open the box and find it empty. In addition, the elderly and others who suffer from limited physical capabilities find it challenging to make it to the mailbox on even the clearest of days, left with no mail, the trip to the mailbox for them can result in fruitless exertion.

The present invention, hereinafter referred as You've Got Mail, offers a convenient solution to the aforementioned problem. You've Got Mail is a transmitting and receiving system that provides an audible alert, inside the home, that mail has been left in an outside box. The transmitter is an electronic unit featuring a frequency generator, amplifier, internal antenna, and the required electrical and electronic components and circuitry encased within a durable plastic housing. Also enclosed within the plastic housing, a battery source is used to power the unit. This transmitter is wired into the flag of the mailbox, and activated as soon as the flag is raised. Rectangular in shape and containing intricate components, the receiver, which is kept inside the home, consists of a tuned frequency, receiver circuit, replaceable silver oxide battery, such as the type common to wristwatches, and a speaker, all enclosed within a sturdy, plastic housing. As an additional consideration, all components of You've Got Mail are offered in an array of colors to appeal to individual tastes, or to match any home or mailbox motif.

Use and application of You've Got Mail is very simple and straightforward. First, the user carefully follows package instructions for installing the transmitter within the mailbox. Next, the receiver is positioned in an easily accessible place within the home, such as on a kitchen countertop or adhered above the entrance door. When the mail carrier inserts mail and raises the flag, a signal is generated and transmitted. The companion receiving unit, which is inside the house, is tuned to the specific frequency generated by the transmitter unit. Upon reception of the signal generated by the transmitter, the circuitry in the receiver generates an enable signal to a logic device (an ‘AND’ integrated circuit chip or comparable) which applies a voltage level to the speaker unit, causing the receiver to be activated. The speaker then emits a continuous audible message which is easily heard, such as “You have mail.” With such an audible beacon, the user knows for sure that mail has arrived, and can confidently retrieve it. At the same time, no activation of the unit informs that no mail has been left, thus there is no need to go to the mailbox.

There are several significant benefits and advantages associated with this clever product invention. Foremost, You've Got Mail offers consumers a simple and effective means of determining when mail has been deposited in an outside box, right from the comforts of indoors. A technologically advanced transmitting and receiving system, this clever product eliminates the guesswork that is commonly associated with retrieving mail from exterior mailboxes. With an audible message emanating inside the house, You've Got Mail handily informs homeowners of the arrival of mail, allowing them to avoid braving stormy or excessively hot weather only to encounter an empty box. Moreover, this product is especially beneficial to the elderly and disabled, as a non-active receiver readily informs them that there is no need to attempt an arduous, wasteful trip to the mailbox. Manufactured of durable, high quality materials and components, this product withstands years of continued use. You've Got Mail is an innovative product invention that readily enhances the convenience of outdoor mailboxes. Created specifically to prevent unnecessary trips to check for mail, this practical product proves invaluable to homeowners in rural and suburban areas.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A mail delivery signaling system, comprising:
a transmitting and receiving system that provides an audible alert, inside the home, that mail has been left in an outside box, wherein the transmitter is an electronic unit comprising a frequency generator, amplifier, internal antenna, and the required electrical and electronic components and circuitry encased within a durable plastic housing.

2. The device of claim 1, further comprising a battery compartment enclosed within the plastic housing, wherein the battery source is used to power the unit.

3. The device of claim 1 wherein the transmitter is wired into the flag of the mailbox, and activated as soon as the flag is raised.

4. The device of claim 1, wherein the housing is essentially rectangular in shape and contains, the receiver, which is kept inside the home, consisting of a tuned frequency, receiver circuit, replaceable silver oxide battery, such as the type common to wristwatches, and a speaker, all enclosed within the durable, plastic housing.
